(19) United States
(12) Patent Application Publication
(10) Pub. No.: US 2005/0186420 A1
(43) Pub. Date: Aug. 25, 2005

(54) Stationery

(76) Inventor: Stephen Paul Black, Stourbridge (GB)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/064,399

(22) Filed: Feb. 23, 2005

(30) Foreign Application Priority Data
Feb. 24, 2004 (GB) GB 0403989.7

(51) Int. Cl. B32B 29/00

(52) U.S. Cl. 428/346; 428/537.5

(57) ABSTRACT

A stationery form is provided with adhesive regions that do not adhere to each other until the adhesive has been activated. The adhesive is heat activated without melting by passage through a laser printer prior to folding the printed form about at least one crease line to secure the form in a folded position.

### CROSS-REFERENCE TO RELATED APPLICATIONS

This application claims priority from British Application No. GB0403989.7, filed 24 Feb. 2004 (incorporated by reference herein).

### TECHNICAL FIELD

This invention concerns improvements in or relating to stationery. The invention has particular application to stationery forms comprising a single sheet of paper which may be printed and folded about one or more crease lines to conceal the printing and secure the form in a folded condition by means of adhesive whereby the form may be sent through the post without requiring the use of a separate envelope.

### BACKGROUND OF THE INVENTION

Forms of this type are known in which the adhesive is applied as a continuous strip around the marginal edge of the form clear of the printable region of the form. The adhesive may be water activated such as a gum which the user wets, e.g. by licking, and then presses to seal the form in the folded condition by finger pressure applied to the adhesive region of the folded form. Alternatively, the adhesive may be self-sealing such as a contact adhesive which does not require wetting or any other activation prior to sealing the form in the folded condition. Contact adhesives are more suitable for high speed processing of a large number of forms that are printed and then folded and secured automatically.

A disadvantage of contact adhesives is that care is required to design the form so that the adhesive is applied to areas of the form that do not come into contact with each other prior to folding and securing the form. In addition, when the forms are arranged in a stack for feeding individual forms to a printer, the adhesive areas on adjacent forms must not come into contact or this may cause the forms to stick together and cause a mis-feed. This places a restriction on the design of the forms and way in which the forms can be folded and secured.

Another disadvantage of contact adhesives is that, even when the adhesive areas on adjacent forms in a stack of forms do not come into contact, the adhesive areas on one form can have an adverse effect on the smooth feeding of forms into a printer, especially inkjet printers, due to the drag created by the contact adhesive when the form being fed to the printer slides over an underlying stationary form. As a result, this can lead to a mis-feed with more than one form being fed into the printer that creates further problems when the forms are delivered to a sealing machine to fold and secure the forms. This can be a particular problem at warm ambient temperatures when using printers with feed rollers that results in extra forms being dragged into the printer. This problem is often referred to as “blocking”.

### SUMMARY OF THE INVENTION

The present invention has been made from a consideration of the foregoing problems and seeks to provide an improved stationery form in which these problems are mitigated.

The present invention also seeks to provide an improved method of folding and securing stationery forms in a folded condition that has particular, but not exclusive application to laser printers.

According to a first aspect of the invention there is provided a stationery form comprising a single sheet of paper or similar printable material having adhesive regions that contact each other when the form is folded and can adhere to each other after heat activation of the adhesive.

By this invention, the regions of the form that are to be secured in the folded condition are provided with a dry adhesive that is inactive so as not to adhere to itself or to a substrate such as another form until it has been activated by exposure to an elevated temperature. As used herein, the term “heat activated” is used to describe a process in which the adhesive changes from a condition in which substrates to which the adhesive is applied do not stick to each other to one in which they do. The exact mechanism by which such change occurs is not properly known to me but it is currently believed that a chemical change occurs when the adhesive is heated which causes the adhesive to change from its inactive to its active condition. This is completely different to so-called “heat seal” adhesives that are exposed to high temperatures in order to melt the adhesive to effect adhesion to a substrate. Such change of the physical state of the adhesive can lead to migration of the adhesive and the term “heat activated” is to be construed as excluding “heat seal” adhesives.

Preferably the adhesive is a latex based adhesive that becomes self-sealing after heat activation. As a result, adhesive regions do not adhere to each other when they come into contact prior to heat activation of the adhesive and readily adhere on contact after heat activation of the adhesive. In this way, after heat activation, the adhesive has properties similar to a contact adhesive.

Moreover, forms can be provided with adhesive regions that contact each other when the forms are stacked for supply to printer without adhering to each other. This results in greater freedom and flexibility in the design of forms and the manner of folding the forms.

Furthermore, I have found that forms can slide relative to each other with reduced drag where adhesive regions contact an adjacent form. As a result, feeding of forms to a printer from a stack of forms is smoother with less risk of mis-feeds due to forms sticking to each other.

After heat activation, contacting adhesive regions may adhere releasably to each other until sufficient pressure is applied to cause the adhesive regions to adhere irreversibly to each other. For example the adhesive regions may adhere releasably under finger pressure and irreversibly at higher pressures such as in sealing machine. More preferably, however, contacting adhesive regions adhere irreversibly on coming into contact after heat activation. For example, the adhesive regions may adhere irreversibly under finger pressure.

The heat activation may be effected by passing the forms through a heater prior to folding and securing the forms in a folded condition. The heater may be any suitable type, for example infra-red or ultra-violet, and may be arranged upstream or downstream of the printer. Alternatively, the heat activation may be effected with the forms in a folded condition.

Preferably, the adhesive is activated by exposure to a temperature above 35° C., preferably above 40° C., and more preferably at least 60° C. I have found that the adhesive can be activated at these temperatures by passage through a laser printer. As a result, in a preferred arrangement, the heat activation is effected by the heat generated by a printer for printing the forms, especially a laser printer, and the printed forms are then folded and secured downstream of the printer.

According to a second aspect of the invention, there is provided a method of securing a stationery form in a folded condition by providing the form with adhesive regions that contact each other in the folded condition and adhere to each other after heat activation of the adhesive.

Preferably, the method includes the step of heat activating the adhesive prior to folding the printed form. For example, the adhesive may be heat activated after printing. More preferably, however, the adhesive is heat activated by the heat generated during printing. For example, the adhesive may be heat activated by passage through a laser printer operating at a temperature above 35° C., preferably above 40° C. and more preferably at least 60° C.

According to a third aspect of the invention, there is provided an adhesive for a stationery form according to the first aspect of the invention or for use in the method according to the second aspect of the invention comprising a latex based adhesive that has a low tack prior to heat activation such that substrates to which the adhesive is applied do not adhere to each other prior to heat activation of the adhesive.

Preferably the adhesive is latex based. For example, the adhesive may be provided as a latex dispersion stabilised with ammonia and blended with an acrylic solution.

After application, the adhesive is dried to remove moisture and leave the dry adhesive in an inactive condition. Drying may be effected using radio frequency or other suitable methods such as ultra-violet, hot air, heat set etc., in a controlled manner to prevent activation of the dry adhesive.

Preferably the adhesive includes one or more additives to aid control of the drying. For example, the adhesive may contain a polyolefin glycol such as polyethylene glycol, especially polyethylene glycol 400. Diethylene glycol may be provided in an amount of up to 4% by weight.

The adhesive may also include one or more additives to improve adhesion levels of the activated adhesive. For example, the adhesive may contain a small amount of glycerine.

The invention will now be described in more detail by way of example only with reference to the accompanying drawings.

### BRIEF DESCRIPTION OF THE DRAWINGS

FIG. 1 is a plan view of a stationery form embodying the invention in a flat, unfolded condition; and

FIG. 2 is a plan view of the form shown in FIG. 1 in a folded and sealed condition.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

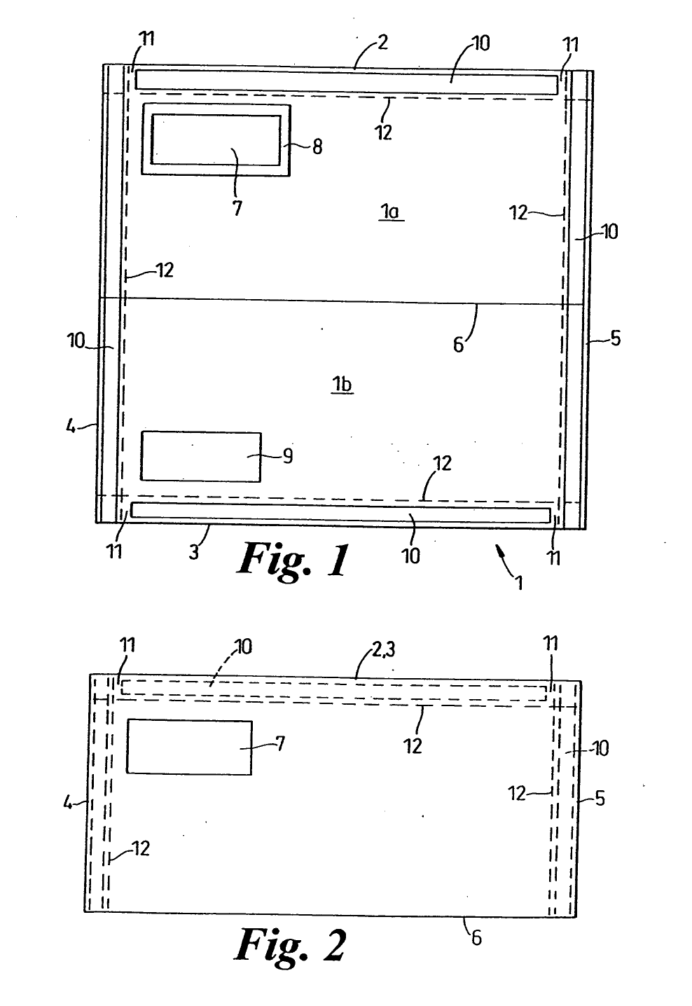

Referring to FIGS. 1 and 2 of the drawings, a stationery form 1 is shown comprising a single sheet of A4 size paper. Other sizes of paper may be employed and the following description embraces all sizes. The paper is compatible for laser printing and has a top edge 2, a bottom edge 3 and opposed side edges 4, 5.

A fold or crease line 6 is provided mid-way between the top and bottom edges 2, 3 to divide the form 1 into a top half la and a bottom half lb. The crease line 6 facilitates folding the form 1 in half to superimpose the two halves 1a, 1b in a folded condition of the form shown in FIG. 2 when it is desired to close and seal the form 1 as described later. The crease line 6 may be formed by any suitable means and, in this embodiment, comprises a line of perforations in the paper.

The top half la is formed with a rectangular window 7 cut out of the paper in a corner region of the form 1. The window 7 is covered by a strip 8 of transparent or translucent material adhesively sealed around the marginal edge of the window 7 on the side of the form 1 which is innermost in the folded condition.

The window 7 is arranged to align with an opposed rectangular section 9 in a corner region on the bottom half 1b of the form in the folded condition. The section 9 is arranged to be printed with the name and address of the recipient of the form 1 so as to be seen through the window 7 in the folded condition of the form 1. In this way, this information can be printed at the same time as the form 1 is printed with the information to be sent to the recipient. As a result, the form 1 can be printed with all required information in a single operation and thereafter folded and sealed ready to send out in the post without requiring a separate operation to apply the name and address to the form 1.

As best shown in FIG. 1, adhesive 10 is provided on one side of the form 1 being the same side as that which is printed with the information to be sent to the recipient and which is innermost in the folded condition of the form 1. The adhesive 10 is applied as a narrow border strip inboard of the top and bottom edges 2, 3 and inboard of the side edges 4, 5.

The adhesive 10 is continuous along the length of the side edges 4, 5 and is discontinuous along the length of the top and bottom edges 2, 3 so that a narrow gap 11 is provided at each corner region between the side edges 4, 5 and the top and bottom edges 2, 3. The gaps 11 on the top half 1a are provided at the same position as the gaps 11 on the bottom half 1b so that, in the folded condition of the form 1 shown in FIG. 2, they are aligned and define openings through which air trapped inside the folded and sealed form 1 can escape. As will be appreciated, the number and arrangement of the gaps 11 can be altered from that illustrated provided that, when the form 1 is folded, at least one opening is formed for trapped air to escape.

The adhesive 10 is based on a latex dispersion stabilised with ammonia and blended with an acrylic solution. After application, the adhesive is dried using radio frequency to remove moisture and leave the dry adhesive behind in an inactive condition in which it does not adhere to itself. It will be understood however that other forms of drying could be used with appropriate control to ensure the dry adhesive is left in its inactive condition. The dry adhesive 10 has a low tack in its inactive condition so that adhesive regions do not adhere to each other and allow forms 1 to slide over each other with a minimum drag. As a result, the forms 1 can be fed to a printer smoothly and the risk of mis-feed from a stack of forms 1 is considerably reduced.

The dry adhesive 10 is activated by exposure to a heat source and, after activation, adhesive regions adhere to each other and the bond formed is substantially irreversible even at low pressures such as finger pressure. Heat activation requires exposure of the adhesive to a temperature over 35° C., preferably above 40° C., and more preferably at least 60° C. In this way, the adhesive does not become activated by exposure to ambient temperatures.

It will be understood that heat activation may be achieved if the adhesive is exposed to temperatures higher than these without detriment provided the adhesive does not melt. In other words, the adhesive is touch dry in both the inactive and active conditions and migration of the adhesive is prevented. Accordingly, an upper temperature limit for heat activation of the adhesive may be lower than the temperature at which the adhesive would melt. In general, however, we may prefer to employ an upper temperature limit of the order of 95° C. and more preferably 85° C. A suitable adhesive is available from National Adhesive under the No. 1350009A/1.

One source of heat to activate the adhesive is provided by laser printers, for example Hewlett Packard 4050 and 4100 desk top laser printers are found to generate sufficient heat to activate the adhesive 10 and allow printed forms 1 to be folded and secured after printing. For example, the printer may be combined with a sealing machine to automatically fold and secure printed forms 1 supplied from the printer. It will be understood, however, that other forms of heating may be employed where the printer does not generate sufficient heat to activate the adhesive. For example, where an inkjet printer is employed to print the forms, a separate heater may be provided to active the adhesive. The adhesive may be activated prior to after printing the form or even after the printed form has been folded.

To facilitate opening of the folded and secured form 1, perforations 12 or other lines of weakness are provided inboard of the adhesive 10 along the top and bottom edges 2, 3 and the side edges 4, 5. These perforations 12 are substantially aligned in the folded and sealed condition of the form 1 and allow the adhesively bonded edge regions to be removed by tearing along the perforations to open the form 1 and allow the information printed thereon to be read. This method of opening a permanently sealed form 1 provides a degree of security where the information printed on the form 1 is confidential as it will be readily apparent if the form 1 has been opened by tearing along the perforations 12.

It will be understood that the invention is not limited to the embodiment above-described. For example, the form 1 may be designed to be folded and secured in a variety of ways as will be familiar to those skilled in the art. For example, the form may be a C-fold or Z-fold type with adhesive regions on both sides of the form. The low tack of the dry adhesive in the inactive condition permits a wide range of adhesive patterns and methods of folding to be employed as it does not matter if adhesive regions contact each other either on the same form or adjacent forms in a stack of forms with the dry adhesive in its inactive condition. This provides greater freedom and flexibility for the form designer. Furthermore, because the adhesive does not melt when activated, migration of the adhesive is prevented. As a result, when activated, the adhesive does not spread to other regions of the form, e.g. inboard of the perforations, where it could obscure the printing and/or prevent the form opening after the adhesively bonded edge regions have been removed.

While the specific embodiments have been illustrated and described, numerous modifications come to mind without significantly departing from the spirit of the invention, and the scope of protection is only limited by the scope of the accompanying claims.

1. A stationery form comprising a single sheet of paper or similar printable material having adhesive regions that contact each other when the form is folded and can adhere to each other after heat activation of the adhesive.

2. A stationery form as claimed in claim 1 wherein said adhesive is dry in both an inactive state so as not to adhere to itself or to a substrate such as another form, and in an active state so as not to migrate from said adhesive regions.

3. A stationery form as claimed in claim 1 wherein said adhesive is a latex based adhesive that becomes self-sealing after heat activation.

4. A stationery form as claimed in claim 3 wherein said adhesive is provided as a latex dispersion stabilised with ammonia and blended with an acrylic solution.

5. A stationery form as claimed in claim 4 wherein said adhesive includes one or more additives to aid drying of the adhesive in a controlled manner.

6. A stationery form as claimed in claim 5 wherein said adhesive contains a polyolefin glycol.

7. A stationery form as claimed in claim 5 wherein said adhesive includes one or more additives to improve adhesion levels of the activated adhesive.

8. A stationery form as claimed in claim 7 wherein said adhesive contains a small amount of glycerine.

9. A stationery form as claimed in claim 1 wherein said adhesive regions are arranged such that, when a plurality of forms are stacked for supply to a printer, adhesive regions of adjacent forms contact each other without adhering to each other.

10. A stationery form as claimed in claim 1 wherein, after heat activation, contacting adhesive regions adhere releasably to each other until sufficient pressure is applied to cause the adhesive regions to adhere irreversibly to each other.

11. A stationery form as claimed in claim 10 wherein said adhesive regions adhere releasably under finger pressure and irreversibly at higher pressures.

12. A stationery form as claimed in claim 1 wherein said adhesive regions adhere irreversibly on coming into contact after heat activation.

13. A stationery form as claimed in claim 1 wherein said adhesive regions are heat activated by passing the forms through a heater prior to folding and securing the forms in a folded condition.

14. A stationery form as claimed in claim 1 wherein said adhesive regions are heat activated with the form in a folded condition.

15. A stationery form as claimed in claim 1 wherein said adhesive is activated by exposure to a temperature in the range 35° C. to 95° C. without melting said adhesive.

16. A stationery form as claimed in claim 1 wherein said adhesive is activated by passage through a laser printer.

17. A method of securing a stationery form in a folded condition by providing the form with adhesive regions that contact each other in the folded condition and adhere to each other after heat activation of the adhesive.

18. A method as claimed in claim 17 further including the step of heat activating said adhesive prior to folding the printed form.

19. A method as claimed in claim 17 wherein said adhesive is heat activated by the heat generated during printing.

20. A method as claimed in claim 19 wherein said adhesive is heat activated by passage through a laser printer operating at a temperature in the range 35° C. to 95° C. such that said adhesive is activated without melting.
